(19) United States
(12) Patent Application Publication
(10) Pub. No.: US 2022/0232563 A1
(43) Pub. Date: Jul. 21, 2022

(54) METHOD AND DEVICE IN NODES USED FOR WIRELESS COMMUNICATION

(71) Applicant: Xiaobo ZHANG, SHANGHAI (CN)

(72) Inventor: Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/579,611

(22) Filed: Jan. 20, 2022

(30) Foreign Application Priority Data
Jan. 21, 2021 (CN) 202110082681.0
Jan. 27, 2021 (CN) 202110108741.1

(51) Int. Cl. H04W 72/04; H04W 72/12

(52) U.S. Cl. CPC H04W 72/0446; H04W 72/1268

(57) ABSTRACT

The present disclosure provides a method and a device in a node for wireless communications. A first receiver receives a first signaling; a first transmitter transmits a first bit block, or, drops transmitting a bit block indicating a first status; herein, the first signaling is used to determine a first radio resource pool; a first status is associated with the first signaling; a first-type radio resource pool is reserved for a first-type bit block; when the first radio resource pool and the first-type radio resource pool are non-overlapping in time domain, the first transmitter drops transmitting a bit block indicating the first status; when the first radio resource pool and a said first-type radio resource pool are overlapping in time domain, the first transmitter transmits the first bit block in the said first-type radio resource pool, the first bit block indicating the first status.

### CROSS REFERENCE TO RELATED APPLICATIONS

This application claims the priority benefit of Chinese Patent Application No.202110082681.0, filed on Jan. 21, 2021, and the priority benefit of Chinese Patent Application No.202110108741.1, field on Jan. 27, 2021, the full disclosure of which is incorporated herein by reference.

### BACKGROUND

### Technical Field

The present disclosure relates to transmission methods and devices in wireless communication systems, and in particular to a method and device for radio signal transmission in a wireless communication system supporting cellular networks.

### Related Art

In a 5G NR system, the 3rd Generation Partner Project (3GPP) conducts studies in many aspects of advancement of Hybrid Automatic Repeat reQuest ACKnowledgement (HARQ-ACK) in its different Release versions, with an aim to support communication traffics of different types and for different requirements; the mode of NACK only feedback is also a scheme of advancement for consideration.

### SUMMARY

After introducing a new HARQ-ACK feedback mode, how to process the multiplexing of HARQ-ACK with other information, such as a Transport Block (TB) carrying user data and a Channel State Information report (CSI report), has become a key issue that remains to be addressed. In view of such issue, the present disclosure provides a solution. The statement above only took Uplink (UL) for example; but the present disclosure also applies to Downlink (DL) and Sidelink (SL) transmission scenarios, where similar technical effect can be achieved. Additionally, the adoption of a unified solution for various scenarios, including but not limited to UL, DL and SL, contributes to the reduction of hardcore complexity and costs. It should be noted that if no conflict is incurred, embodiments in a User Equipment (UE) in the present disclosure and the characteristics of the embodiments are also applicable to a base station, and vice versa. What's more, the embodiments in the present disclosure and the characteristics in the embodiments can be arbitrarily combined if there is no conflict.

In one embodiment, interpretations of the terminology in the present disclosure refer to definitions given in the 3GPP TS36 series.

In one embodiment, interpretations of the terminology in the present disclosure refer to definitions given in the 3GPP TS38 series.

In one embodiment, interpretations of the terminology in the present disclosure refer to definitions given in the 3GPP TS37 series.

In one embodiment, interpretations of the terminology in the present disclosure refer to definitions given in Institute of Electrical and Electronics Engineers (IEEE) protocol specifications.

The present disclosure provides a method in a first node for wireless communications, comprising:

receiving a first signaling; and

transmitting a first bit block, or, dropping transmitting a bit block which indicates a first status;

herein, the first signaling is used to determine a first radio resource pool; the first status is associated with the first signaling; a first-type radio resource pool is reserved for a first-type bit block; when the first radio resource pool and the first-type radio resource pool are non-overlapping in time domain, dropping transmitting the bit block which indicates the first status; when the first radio resource pool and a said first-type radio resource pool are overlapping in time domain, transmitting the first bit block in the said first-type radio resource pool, the first bit block indicating the first status, the first bit block does not belong to the first-type bit block.

In one embodiment, a problem to be solved in the present disclosure comprises: how to report the first status to the base station.

In one embodiment, characteristics of the above method include: even when there isn't any would-be transmitted PUCCH that is overlapping with a PUSCH, a HARQ-ACK information bit block indicating the first status is still likely to be multiplexed onto the PUSCH for transmission.

In one embodiment, characteristics of the above method include: the first radio resource pool does not comprise any PUCCH to be transmitted.

In one embodiment, an advantage of the above method is to avoid unnecessary blind detection.

In one embodiment, an advantage of the above method is to reduce the risk of any possible erroneous communication resulting from decoding error.

In one embodiment, an advantage of the above method is to enhance the uplink transmission performance.

In one embodiment, an advantage of the above method is to take better advantage of information multiplexing in transmission performance.

In one embodiment, an advantage of the above method is to be compatible to more HARQ-ACK reporting modes.

According to one aspect of the present disclosure, the above method is characterized in that,

the first status is fulfilled.

According to one aspect of the present disclosure, the above method is characterized in that,

the first status is a status related to reception of a bit block.

According to one aspect of the present disclosure, the above method is characterized in that,

the first radio resource pool is reserved for a bit block which indicates a second status, the second status being different from the first status, the first status and the second status are both statuses related to reception of a bit block.

According to one aspect of the present disclosure, the above method is characterized in that,

each bit comprised in the first bit block denotes a NACK.

According to one aspect of the present disclosure, the above method is characterized in comprising:

receiving a second signaling;

transmitting a first signal in a second radio resource pool, the first signal carrying a second bit block;

herein, the second bit block belongs to the first-type bit blocks, the second radio resource pool is a said first-type radio resource pool, and the second signaling is used to indicate the second radio resource pool.

According to one aspect of the present disclosure, the above method is characterized in that,

when the first radio resource pool is overlapping with multiple said first-type radio resource pools in time domain; a number of bits comprised in the first bit block is used to determine in which one of the multiple said first-type radio resource pools the first bit block is to be transmitted.

In one embodiment, an advantage of the above method is that UCI multiplexing can be optimized by making a rational compromise between two aspects: delay and reliability.

According to one aspect of the present disclosure, the above method is characterized in that,

when the first radio resource pool and a said first-type radio resource pool are overlapping in time domain, each of timeline condition(s) required to be fulfilled is fulfilled; the first radio resource pool is a second-type radio resource pool, the second-type radio resource pool being a radio resource pool reserved for a PUCCH, the first radio resource pool is non-overlapping with any of the second-type radio resource pools other than the first radio resource pool in time domain.

According to one aspect of the present disclosure, the above method is characterized in that,

the first status comprises: a bit block scheduled by the first signaling is correctly decoded.

According to one aspect of the present disclosure, the above method is characterized in that,

the first radio resource pool is reserved for a PUCCH, and the first-type radio resource pool is a radio resource occupied by a PUSCH.

According to one aspect of the present disclosure, the above method is characterized in that,

the first status comprises: a bit block scheduled by the first signaling is correctly decoded; each bit comprised in the first bit block represents an ACK.

According to one aspect of the present disclosure, the above method is characterized in that,

the first-type bit block is a bit block comprising at least one of a Transport Block (TB) or a CSI report being indicated for transmission in a PUSCH; the first-type radio resource pool is a radio resource occupied by the PUSCH.

According to one aspect of the present disclosure, the above method is characterized in comprising:

receiving multiple signalings, the multiple signalings comprising the first signaling;

herein, the multiple signalings are respectively used to indicate scheduling information for multiple bit blocks, any of the multiple bit blocks comprises a TB, and the multiple bit blocks are correctly decoded; the first status is: the multiple bit blocks being correctly decoded.

According to one aspect of the present disclosure, the above method is characterized in that,

the first-type bit block is a bit block comprising at least one of a Transport Block (TB) or a CSI report being indicated for transmission in a PUSCH; each bit comprised in the first bit block represents an ACK.

The present disclosure provides a method in a second node for wireless communications, comprising:

transmitting a first signaling; and

performing listening in a first radio resource pool or at least one first-type radio resource pool;

herein, the first signaling is used to determine a first radio resource pool; a first-type radio resource pool is reserved for a first-type bit block; when the first radio resource pool and the first-type radio resource pool are non-overlapping in time domain, performing listening in the first radio resource pool; when the first radio resource pool and a said first-type radio resource pool are overlapping in time domain, performing listening in the said first-type radio resource pool.

According to one aspect of the present disclosure, the above method is characterized in that,

the first radio resource pool is reserved for a bit block which indicates a second status, the second status being different from the first status, the first status and the second status are both statuses related to reception of a bit block.

According to one aspect of the present disclosure, the above method is characterized in that,

when the first radio resource pool and the first-type radio resource pool are non-overlapping in time domain, listening is performed on a bit block which indicates a second status in the first radio resource pool, and listening is not performed on a bit block which indicates a first status in the first radio resource pool.

According to one aspect of the present disclosure, the above method is characterized in that,

when the first radio resource pool and a said first-type radio resource pool are overlapping in time domain, listening is performed on a bit block which indicates a first status or a second status in the said first-type radio resource pool.

According to one aspect of the present disclosure, the above method is characterized in that,

when the first radio resource pool is overlapping with multiple said first-type radio resource pools in time domain; it is determined that listening is performed on a bit block which indicates a first status or a second status, a number of bits comprised in the bit block which indicates the first status or the second status is used to determine in which one of the multiple said first-type radio resource pools the listening will be performed on the bit block which indicates the first status or the second status.

According to one aspect of the present disclosure, the above method is characterized in comprising:

transmitting a second signaling;

receiving a first signal in a second radio resource pool, the first signal carrying a second bit block;

herein, the second bit block belongs to the first-type bit blocks, the second radio resource pool is a said first-type radio resource pool, and the second signaling is used to indicate the second radio resource pool.

The present disclosure provides a first node for wireless communications, comprising:

a first receiver, receiving a first signaling; and

a first transmitter, transmitting a first bit block, or, dropping transmitting a bit block which indicates a first status;

herein, the first signaling is used to determine a first radio resource pool; the first status is associated with the first signaling; a first-type radio resource pool is reserved for a first-type bit block; when the first radio resource pool and the first-type radio resource pool are non-overlapping in time domain, the first transmitter drops transmitting a bit block which indicates the first status; when the first radio resource pool and a said first-type radio resource pool are overlapping in time domain, the first transmitter transmits the first bit block in a said first-type radio resource pool, the first bit block indicating the first status, the first bit block does not belong to the first-type bit block.

The present disclosure provides a second node for wireless communications, comprising:

a second transmitter, transmitting a first signaling;

a second receiver, performing listening in a first radio resource pool or at least one first-type radio resource pool;

herein, the first signaling is used to determine a first radio resource pool; a first-type radio resource pool is reserved for a first-type bit block; when the first radio resource pool and the first-type radio resource pool are non-overlapping in time domain, the second receiver performs listening in the first radio resource pool; when the first radio resource pool and a said first-type radio resource pool are overlapping in time domain, the second receiver performs listening in the said first-type radio resource pool.

In one embodiment, the method in the present disclosure has the following advantages:

being supportive to integration of NACK-only (or ACK-only) PUCCH feedback scheme with other schemes;
avoiding unnecessary blind detection;
reducing potential risks of erroneous dissemination;
improving uplink transmission performance;
providing better compatibility with more diverse modes of HARQ-ACK reporting;
optimizing UCI multiplexing while rationally balancing the delay and the reliability.

### BRIEF DESCRIPTION OF THE DRAWINGS

Other features, objects and advantages of the present disclosure will become more apparent from the detailed description of non-restrictive embodiments taken in conjunction with the following drawings:

FIG. 1 illustrates a flowchart of processing of a first node according to one embodiment of the present disclosure.

FIG. 2 illustrates a schematic diagram of a network architecture according to one embodiment of the present disclosure.

FIG. 3 illustrates a schematic diagram of a radio protocol architecture of a user plane and a control plane according to one embodiment of the present disclosure.

FIG. 4 illustrates a schematic diagram of a first communication device and a second communication device according to one embodiment of the present disclosure.

FIG. 5 illustrates a flowchart of signal transmission according to one embodiment of the present disclosure.

FIG. 6 illustrates a flowchart of processing of a first node on a second signaling and a first signal according to one embodiment of the present disclosure.

FIG. 7 illustrates a schematic diagram of a first status and a second status according to one embodiment of the present disclosure.

FIG. 8 illustrates a schematic diagram illustrating a first radio resource pool according to one embodiment of the present disclosure.

FIG. 9 illustrates a schematic diagram of relationship between a number of bits comprised in a first bit block and a first-type radio resource pool used for transmitting a first bit block according to one embodiment of the present disclosure.

FIG. 10 illustrates a structure block diagram of a processing device in a first node according to one embodiment of the present disclosure.

FIG. 11 illustrates a structure block diagram a processing device in a second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1

Embodiment 1 illustrates a flowchart of processing of a first node, as shown in FIG. 1.

In Embodiment 1, the first node in the present disclosure receives a first signaling in step 101; transmits a first bit block, or drops transmitting a bit block which indicates a first status in step 102.

In Embodiment 1, the first signaling is used to determine a first radio resource pool; the first status is associated with the first signaling; a first-type radio resource pool is reserved for a first-type bit block; when the first radio resource pool and the first-type radio resource pool are non-overlapping in time domain, the first node drops transmitting the bit block which indicates the first status; when the first radio resource pool and a said first-type radio resource pool are overlapping in time domain, the first node transmits the first bit block in the said first-type radio resource pool, the first bit block indicating the first status, the first bit block does not belong to the first-type bit block.

In one embodiment, the first signaling is dynamically configured.

In one embodiment, the first signaling comprises a layer 1 (L1) signaling.

In one embodiment, the first signaling comprises a layer 1 (L1) control signaling.

In one embodiment, the first signaling comprises a Physical Layer signaling.

In one embodiment, the first signaling comprises one or more fields in a physical layer signaling.

In one embodiment, the first signaling comprises a Higher Layer signaling.

In one embodiment, the first signaling comprises one or more fields in a Higher Layer signaling.

In one embodiment, the first signaling comprises a Radio Resource Control (RRC) signaling.

In one embodiment, the first signaling comprises a Medium Access Control layer Control Element (MAC CE) signaling.

In one embodiment, the first signaling comprises one or more fields in an RRC signaling.

In one embodiment, the first signaling comprises one or more fields in a MAC CE signaling.

In one embodiment, the first signaling is an RRC signaling.

In one embodiment, the first signaling is a MAC CE signaling.

In one embodiment, the first signaling comprises Downlink Control Information (DCI).

In one embodiment, the first signaling comprises one or more fields in a DCI.

In one embodiment, the first signaling is a DCI.

In one embodiment, the first signaling is a field in a DCI.

In one embodiment, the first signaling comprises Sidelink Control Information (SCI).

In one embodiment, the first signaling comprises one or more fields in an SCI.

In one embodiment, the first signaling comprises one or more fields in an Information Element (IE).

In one embodiment, the first signaling is a DownLink Grant Signaling.

In one embodiment, the first signaling is an UpLink Grant Signaling.

In one embodiment, the first signaling is transmitted in a downlink physical layer control channel (i.e., a downlink channel only capable of bearing physical layer signaling).

In one embodiment, the downlink physical layer control channel is a Physical Downlink Control CHannel (PDCCH).

In one embodiment, the downlink physical layer control channel is a short PDCCH (sPDCCH).

In one embodiment, the downlink physical layer control channel is a Narrow Band PDCCH (NB-PDCCH).

In one embodiment, the first signaling is DCI format 1_0, for the specific definition of the DCI format 1_0, refer to 3GPP TS38.212, Chapter 7.3.1.2.

In one embodiment, the first signaling is DCI format 1_1, for the specific definition of the DCI format 1_1, refer to 3GPP TS38.212, Chapter 7.3.1.2.

In one embodiment, the first signaling is DCI format 1_2, for the specific definition of the DCI format 1_2, refer to 3GPP TS38.212, Chapter 7.3.1.2.

In one embodiment, the first signaling is DCI format 0_0, for the specific definition of the DCI format 0_0, refer to 3GPP TS38.212, Chapter 7.3.1.1.

In one embodiment, the first signaling is DCI format 0_1, for the specific definition of the DCI format 0_1, refer to 3GPP TS38.212, Chapter 7.3.1.1.

In one embodiment, the first signaling is DCI format 0_2, for the specific definition of the DCI format 0_2, refer to 3GPP TS38.212, Chapter 7.3.1.1.

In one embodiment, the first radio resource pool is a said first-type radio resource pool.

In one embodiment, the first radio resource pool is not the first-type radio resource pool.

In one embodiment, the first radio resource pool is not overlapping with other second-type radio resource pools in time domain.

In one embodiment, the first radio resource pool is a second-type radio resource pool.

In one embodiment, the other second-type radio resource pools do not comprise the first radio resource pool.

In one embodiment, the other second-type radio resource pools comprise the second-type radio resource pools other than the first radio resource pool.

In one embodiment, a said second-type radio resource pool is a radio resource pool comprising a PUCCH resource.

In one embodiment, a said second-type radio resource pool is a radio resource pool occupied by a PUCCH resource.

In one embodiment, a said second-type radio resource pool is a radio resource pool reserved for UCI transmission.

In one embodiment, a said second-type radio resource pool is a PUCCH resource.

In one embodiment, a said second-type radio resource pool is a radio resource pool reserved for a PUCCH.

In one embodiment, a said second-type radio resource pool is a radio resource pool comprising a PUCCH resource.

In one embodiment, a said second-type radio resource pool is a radio resource pool reserved for a PUCCH.

In one embodiment, a said second-type radio resource pool is a radio resource occupied by a PUCCH.

In one embodiment, a said second-type radio resource pool is a radio resource pool reserved for a Control Channel.

In one embodiment, a said second-type radio resource pool comprises a PUCCH resource with only NACK reporting.

In one embodiment, a said second-type radio resource pool comprises a PUCCH resource used only for NACK reporting.

In one embodiment, the second-type radio resource pool is not used for reporting ACK.

In one embodiment, a PUCCH resource comprised in the second-type radio resource pool is not used for reporting ACK.

In one embodiment, a said second-type radio resource pool comprises a PUCCH resource with only ACK reporting.

In one embodiment, a said second-type radio resource pool comprises a PUCCH resource used only for ACK reporting.

In one embodiment, the second-type radio resource pool is not used for reporting NACK.

In one embodiment, PUCCH resources comprised in the second-type radio resource pool are not used for reporting NACK.

In one embodiment, a PUCCH resource comprised in a said second-type radio resource pool employs a PUCCH format 0.

In one embodiment, a PUCCH resource comprised in a said second-type radio resource pool employs either a PUCCH format 0 or a PUCCH format 1.

In one embodiment, a PUCCH resource comprised in a said second-type radio resource pool employs one of a PUCCH format 0, a PUCCH format 1, a PUCCH format 2, a PUCCH format 3 or a PUCCH format 4.

In one embodiment, PUCCH resources comprised in the second-type radio resource pool are not supported to employ any of a PUCCH format 2, a PUCCH format 3 or a PUCCH format 4.

In one embodiment, PUCCH resources comprised in the second-type radio resource pool are not supported to employ at least one of a PUCCH format 1, a PUCCH format 2, a PUCCH format 3 or a PUCCH format 4.

In one embodiment, PUCCH resources comprised in the first radio resource pool employ a PUCCH format 0.

In one embodiment, PUCCH resources comprised in the first radio resource pool employ either a PUCCH format 0 or a PUCCH format 1.

In one embodiment, PUCCH resources comprised in the first radio resource pool employ one of a PUCCH format 0, a PUCCH format 1, a PUCCH format 2, a PUCCH format 3 or a PUCCH format 4.

In one embodiment, a said second-type radio resource pool is a radio resource occupied by a control channel.

In one embodiment, a said second-type radio resource pool comprises at least one RE in time-frequency domain.

In one embodiment, a said second-type radio resource pool comprises a positive integer number of subcarrier(s) in frequency domain.

In one embodiment, a said second-type radio resource pool comprises a positive integer number of Physical Resource Block(s) (PRB(s)) in frequency domain.

In one embodiment, a said second-type radio resource pool comprises a positive integer number of Resource Block(s) (RB(s)) in frequency domain.

In one embodiment, a said second-type radio resource pool comprises a positive integer number of multicarrier symbol(s) in time domain.

In one embodiment, a said second-type radio resource pool comprises a positive integer number of slot(s) in time domain.

In one embodiment, a said second-type radio resource pool comprises a positive integer number of sub-slot(s) in time domain.

In one embodiment, a said second-type radio resource pool comprises a positive integer number of millisecond(s) (ms) in time domain.

In one embodiment, a said second-type radio resource pool comprises a positive integer number of consecutive multicarrier symbols in time domain.

In one embodiment, a said second-type radio resource pool comprises a positive integer number of non-consecutive slots in time domain.

In one embodiment, a said second-type radio resource pool comprises a positive integer number of consecutive slots in time domain.

In one embodiment, a said second-type radio resource pool comprises a positive integer number of sub-frame(s) in time domain.

In one embodiment, a said second-type radio resource pool is configured by a physical layer signaling.

In one embodiment, a said second-type radio resource pool is configured by a higher layer signaling.

In one embodiment, a said second-type radio resource pool is configured by a Radio Resource Control (RRC) signaling.

In one embodiment, a said second-type radio resource pool is configured by a Medium Access Control layer Control Element (MAC CE) signaling.

In one embodiment, the first bit block comprises at least one bit.

In one embodiment, the first bit block comprises at least one HARQ-ACK information bit.

In one embodiment, the first bit block comprises a HARQ-ACK codebook.

In one embodiment, the first bit block comprises a HARQ-ACK sub-codebook.

In one embodiment, a bit comprised in the first bit block denotes an ACK.

In one embodiment, a bit comprised in the first bit block denotes a NACK.

In one embodiment, each bit comprised in the first bit block denotes an ACK.

In one embodiment, each bit comprised in the first bit block denotes a NACK.

In one embodiment, the first bit block comprises a HARQ-ACK information bit for MBS services.

In one embodiment, the first bit block comprises an ACK for MBS services.

In one embodiment, the first bit block comprises a NACK for MBS services.

In one embodiment, the first bit block comprises a HARQ-ACK information bit for multicast or broadcast services.

In one embodiment, the first bit block comprises an ACK for multicast or broadcast services.

In one embodiment, the first bit block comprises a NACK for multicast or broadcast services.

In one embodiment, at least one bit comprised in the first bit block indicates the first status.

In one embodiment, at least one bit comprised in the first bit block explicitly indicates the first status.

In one embodiment, at least one bit comprised in the first bit block implicitly indicates the first status.

In one embodiment, a bit block which indicates the first status comprises at least one bit.

In one embodiment, a bit block which indicates the first status comprises at least one HARQ-ACK information bit.

In one embodiment, a bit block which indicates the first status is: a bit block in which a bit comprised denotes an ACK.

In one embodiment, a bit block which indicates the first status is: a bit block in which a bit comprised denotes a NACK.

In one embodiment, a bit block which indicates the first status is: a bit block in which all bits comprised denote an ACK.

In one embodiment, a bit block which indicates the first status is: a bit block in which all bits comprised denote a NACK.

In one embodiment, the first signaling is used to configure the first radio resource pool.

In one embodiment, the first signaling group indicates the first radio resource pool.

In one embodiment, the first signaling group explicitly indicates the first radio resource pool.

In one embodiment, the first signaling group implicitly indicates the first radio resource pool.

In one embodiment, a field comprised in the first signaling is used to indicate the first radio resource pool.

In one embodiment, a PUCCH resource indicator field comprised in the first signaling is used to indicate the first radio resource pool.

In one embodiment, time-domain resources occupied by the first radio resource pool are associated with time-domain resources occupied by the first signaling.

In one embodiment, time-domain resources occupied by the first radio resource pool are associated with time-domain resources occupied by a bit block scheduled by the first signaling.

In one embodiment, frequency-domain resources occupied by the first radio resource pool are associated with frequency-domain resources occupied by the first signaling.

In one embodiment, frequency-domain resources occupied by the first radio resource pool are associated with frequency-domain resources occupied by a bit block scheduled by the first signaling.

In one embodiment, a bit block scheduled by the first signaling comprises one TB.

In one embodiment, a bit block scheduled by the first signaling comprises two TBs.

In one embodiment, a bit block scheduled by the first signaling comprises at least one codeblock group.

In one embodiment, the first radio resource pool comprises at least one Resource Element (RE) in time-frequency domain.

In one embodiment, a said RE occupies a multicarrier symbol in time domain, and a subcarrier in frequency domain.

In one embodiment, the multicarrier symbol in the present disclosure is an Orthogonal Frequency Division Multiplexing (OFDM) Symbol.

In one embodiment, the multicarrier symbol in the present disclosure is a Single Carrier- Frequency Division Multiple Access (SC-FDMA) symbol.

In one embodiment, the multicarrier symbol in the present disclosure is a Discrete Fourier Transform Spread OFDM (DFT-S-OFDM) symbol.

In one embodiment, the multicarrier symbol in the present disclosure is a Filter Bank Multi Carrier (FBMC) symbol.

In one embodiment, the multicarrier symbol in the present disclosure comprises a Cyclic Prefix (CP).

In one embodiment, the first radio resource pool comprises a positive integer number of subcarrier(s) in frequency domain.

In one embodiment, the first radio resource pool comprises a positive integer number of Physical Resource Block(s) (PRB(s)) in frequency domain.

In one embodiment, the first radio resource pool comprises a positive integer number of Resource Block(s) (RB(s)) in frequency domain.

In one embodiment, the first radio resource pool comprises a positive integer number of multicarrier symbol(s) in time domain.

In one embodiment, the first radio resource pool comprises a positive integer number of slot(s) in time domain.

In one embodiment, the first radio resource pool comprises a positive integer number of sub-slot(s) in time domain.

In one embodiment, the first radio resource pool comprises a positive integer number of millisecond(s) (ms) in time domain.

In one embodiment, the first radio resource pool comprises a positive integer number of consecutive multicarrier symbols in time domain.

In one embodiment, the first radio resource pool comprises a positive integer number of non-consecutive slots in time domain.

In one embodiment, the first radio resource pool comprises a positive integer number of consecutive slots in time domain.

In one embodiment, the first radio resource pool comprises a positive integer number of sub-frame(s) in time domain.

In one embodiment, the first radio resource pool is configured by a physical layer signaling.

In one embodiment, the first radio resource pool is configured by a higher layer signaling.

In one embodiment, the first radio resource pool is configured by a Radio Resource Control (RRC) signaling.

In one embodiment, the first radio resource pool is configured by a Medium Access Control layer Control Element (MAC CE) signaling.

In one embodiment, the first radio resource pool is reserved for a physical layer channel.

In one embodiment, the first radio resource pool is reserved for an uplink physical layer channel.

In one embodiment, the first radio resource pool comprises radio resources reserved for an uplink physical layer channel.

In one embodiment, the first radio resource pool comprises radio resources occupied by an uplink physical layer channel.

In one embodiment, the first radio resource pool set comprises a PUCCH resource.

In one embodiment, the first radio resource pool is reserved for a PUCCH.

In one embodiment, the first radio resource pool is a radio resource occupied by a PUCCH resource.

In one embodiment, the first radio resource pool is reserved for a PUCCH with NACK only reporting.

In one embodiment, the first radio resource pool is reserved for a PUCCH with ACK only reporting.

In one embodiment, the first radio resource pool is reserved for a Control Channel.

In one embodiment, a said first-type radio resource pool comprises at least one Resource Element (RE) in time-frequency domain.

In one embodiment, a said first-type radio resource pool comprises a positive integer number of subcarrier(s) in frequency domain.

In one embodiment, a said first-type radio resource pool comprises a positive integer number of Physical Resource Block(s) (PRB(s)) in frequency domain.

In one embodiment, a said first-type radio resource pool comprises a positive integer number of Resource Block(s) (RB(s)) in frequency domain.

In one embodiment, a said first-type radio resource pool comprises a positive integer number of multicarrier symbol(s) in time domain.

In one embodiment, a said first-type radio resource pool comprises a positive integer number of slot(s) in time domain.

In one embodiment, a said first-type radio resource pool comprises a positive integer number of sub-slot(s) in time domain.

In one embodiment, a said first-type radio resource pool comprises a positive integer number of millisecond(s) (ms) in time domain.

In one embodiment, a said first-type radio resource pool comprises a positive integer number of consecutive multicarrier symbols in time domain.

In one embodiment, a said first-type radio resource pool comprises a positive integer number of non-consecutive slots in time domain.

In one embodiment, a said first-type radio resource pool comprises a positive integer number of consecutive slots in time domain.

In one embodiment, a said first-type radio resource pool comprises a positive integer number of sub-frame(s) in time domain.

In one embodiment, a said first-type radio resource pool is configured by a physical layer signaling.

In one embodiment, a said first-type radio resource pool is configured by a higher layer signaling.

In one embodiment, a said first-type radio resource pool is configured by a Radio Resource Control (RRC) signaling.

In one embodiment, a said first-type radio resource pool is configured by a Medium Access Control layer Control Element (MAC CE) signaling.

In one embodiment, a said first-type radio resource pool is reserved for a physical layer channel.

In one embodiment, a said first-type radio resource pool is reserved for an uplink physical layer channel.

In one embodiment, a said first-type radio resource pool comprises radio resources reserved for an uplink physical layer channel.

In one embodiment, a said first-type radio resource pool comprises radio resources occupied by an uplink physical layer channel.

In one embodiment, a said first-type radio resource pool comprises a PUSCH.

In one embodiment, a said first-type radio resource pool is reserved for a PUSCH.

In one embodiment, a said first-type time-frequency resource pool is reserved for a Shared Channel.

In one embodiment, a said first-type radio resource pool is a radio resource occupied by a PUSCH.

In one embodiment, a said first-type radio resource pool comprises a PUCCH resource.

In one embodiment, a said first-type radio resource pool comprises a PUCCH resource reserved for unicast services.

In one embodiment, a said first-type radio resource pool comprises a PUSCH reserved for unicast services.

In one embodiment, a said first-type radio resource pool comprises a PUCCH resource configured for unicast services.

In one embodiment, the first radio resource pool comprises a PUCCH resource reserved for multicast or broadcast services.

In one embodiment, the first radio resource pool comprises a PUCCH resource reserved for Multicast and Broadcast Service(s) (MBS).

In one embodiment, the first radio resource pool comprises a PUCCH resource configured for MBS.

In one embodiment, the first radio resource pool comprises a PUCCH resource configured for multicast or broadcast services.

In one embodiment, a said first-type radio resource pool comprises a PUCCH resource reserved for CSI report/reporting.

In one embodiment, a said first-type radio resource pool comprises a PUCCH resource reserved for periodic CSI reporting.

In one embodiment, a said first-type radio resource pool comprises a PUCCH resource reserved for semi-persistent CSI reporting.

In one embodiment, the first-type bit block comprises at least one bit.

In one embodiment, the first-type bit block comprises at least one Transport Block (TB).

In one embodiment, the first-type bit block comprises at least one Code Block (CB).

In one embodiment, the first-type bit block comprises at least one Code Block Group (CBG).

In one embodiment, the first-type bit block comprises a Channel State Information (CSI) report being indicated for transmission on a PUSCH.

In one embodiment, the first-type bit block is a bit block comprising at least one of a Transport Block (TB) or a CSI report being indicated for transmission in a PUSCH.

In one embodiment, the first-type bit block comprises a periodic CSI report.

In one embodiment, the first-type bit block comprises information bits in a periodic CSI report.

In one embodiment, the first-type bit block comprises a semi-persistent CSI report.

In one embodiment, the first-type bit block comprises information bits in a semi-persistent CSI report.

In one embodiment, the first-type bit block comprises a HARQ-ACK information bit for unicast services.

In one embodiment, the first-type bit block comprises a HARQ-ACK information bit for unicast services or information bits in a CSI report.

In one embodiment, the first-type bit block is a bit block required to be transmitted on a PUSCH.

In one embodiment, the first-type radio resource pool is reserved for transmitting the first-type bit block.

In one embodiment, a physical layer channel occupying the first-type radio resource pool is reserved for transmitting the first-type bit block.

In one embodiment, the first-type radio resource pool is used for bearing the first-type bit block.

In one embodiment, the first-type radio resource pool is used for bearing transmission of the first-type bit block.

In one embodiment, the phrase that a first-type radio resource pool is reserved for a first-type bit block comprises: the first-type radio resource pool is reserved based on indication by a dynamic scheduling signaling (e.g. DCI) or Configured Grant for transmitting the first-type bit blocks.

In one embodiment, the phrase of being non-overlapping in time domain includes: not comprising any same multicarrier symbol.

In one embodiment, the phrase of being overlapping in time domain includes: comprising at least one same multicarrier symbol.

In one embodiment, the phrase of being non-overlapping in time domain includes: not comprising any same time-domain resource.

In one embodiment, the phrase of being overlapping in time domain comprises: comprising at least part of time-domain resources which are the same.

In one embodiment, the first bit block does not comprise any TB.

In one embodiment, the first bit block does not comprise any codeblock.

In one embodiment, the first bit block does not comprise any codeblock group.

In one embodiment, the first bit block does not comprise a CSI report being indicated for transmission on a PUSCH.

In one embodiment, the first bit block neither comprises a TB nor comprises a CSI report being indicated for transmission on a PUSCH.

In one embodiment, relevant descriptions about the first bit block in the present disclosure only targets cases in which the first bit block is generated.

In one embodiment, relevant descriptions about the first bit block in the present disclosure only targets cases in which the first bit block is transmitted.

In one embodiment, the first bit block is generated no matter whether the first bit block is to be transmitted or not.

In one embodiment, the first bit block is generated no matter whether the first radio resource pool and the first-type radio resource pool are overlapping in time domain.

In one embodiment, when the first bit block would be transmitted, the first bit block is generated.

In one embodiment, when the first radio resource pool and a said first-type radio resource pool are overlapping in time domain, the first bit block is generated.

In one embodiment, when a bit block which indicates the first status is dropped to be transmitted, the first bit block is not generated.

In one embodiment, when the first radio resource pool and a said first-type radio resource pool are non-overlapping in time domain, the first bit block is not generated.

In one embodiment, the first node transmitting a bit block means that: the first node transmits a signal carrying the bit block.

In one embodiment, a signal carrying a bit block comprises: an output by all or part of bits in the bit block sequentially through some or all of CRC Insertion, Segmentation, Code Block (CB)-level CRC Insertion, Channel Coding, Rate Matching, Concatenation, Scrambling, Modulation, Layer Mapping, Precoding, Mapping to Resource Element, Multicarrier Symbol Generation, and Modulation and Upconversion.

In one embodiment, whether the first node transmits a bit block which indicates the first status depends upon whether the first radio resource pool is overlapping with the first-type radio resource pool in time domain.

In one embodiment, the phrase of whether to transmit a bit block which indicates the first status means: whether to transmit the first bit block.

In one embodiment, the phrase of whether to transmit a bit block which indicates the first status comprises: transmitting the first bit block, or, dropping transmitting the bit block which indicates the first status.

In one embodiment, the phrase of whether to transmit a bit block which indicates the first status comprises: whether transmitting the first bit block, or, dropping transmitting the bit block which indicates the first status.

In one embodiment, the phrase of dropping transmitting a bit block which indicates (the) first status means: dropping transmitting the first bit block.

In one embodiment, the phrase of dropping transmitting a bit block which indicates (the) first status comprises: dropping transmitting the first bit block.

In one embodiment, the phrase of dropping transmitting a bit block which indicates (the) first status comprises: not transmitting the first bit block.

In one embodiment, the phrase of dropping transmitting a bit block which indicates (the) first status comprises: not transmitting the bit block indicating the first status.

In one embodiment, the phrase of dropping transmitting a bit block which indicates (the) first status comprises: not transmitting any bit block indicating the first status.

In one embodiment, the phrase of dropping transmitting a bit block which indicates (the) first status comprises: dropping transmitting any bit block indicating the first status.

In one embodiment, the phrase of dropping transmitting a bit block which indicates (the) first status comprises: dropping transmitting a HARQ-ACK information bit associated with the first signaling.

In one embodiment, the phrase of dropping transmitting a bit block which indicates (the) first status comprises: not transmitting a HARQ-ACK information bit associated with the first signaling.

In one embodiment, the phrase of dropping transmitting a bit block which indicates (the) first status comprises: not transmitting any signal in the first radio resource pool.

In one embodiment, the phrase of dropping transmitting a bit block which indicates (the) first status comprises: dropping transmitting any signal in the first radio resource pool.

In one embodiment, the phrase of dropping transmitting a bit block which indicates (the) first status comprises: dropping transmitting the bit block which indicates the first status in the first radio resource pool.

In one embodiment, the phrase of dropping transmitting a bit block which indicates (the) first status comprises: dropping transmitting any bit block which indicates the first status in the first radio resource pool.

In one embodiment, the phrase of dropping transmitting a bit block which indicates (the) first status comprises: not transmitting the bit block which indicates the first status in the first radio resource pool.

In one embodiment, the phrase of dropping transmitting a bit block which indicates (the) first status comprises: not transmitting any bit block which indicates the first status in the first radio resource pool.

In one embodiment, the phrase of dropping transmitting a bit block which indicates (the) first status comprises: not transmitting the bit block which indicates the first status in the first radio resource pool.

In one embodiment, the phrase of dropping transmitting a bit block which indicates (the) first status comprises: not transmitting any bit block which indicates the first status in the first radio resource pool.

In one embodiment, the phrase of dropping transmitting a bit block which indicates (the) first status comprises: dropping transmitting a signal carrying a bit block which indicates the first status.

In one embodiment, the first radio resource pool is overlapping with at most one said first-type radio resource pool in time domain.

In one embodiment, the first radio resource pool and the first-type radio resource pool are non-overlapping in time domain, or, the first radio resource pool is overlapping with only one said first-type radio resource pool in time domain, or, the first radio resource pool is overlapping with multiple said first-type radio resource pools in time domain.

In one embodiment, the phrase that the first radio resource pool and the first-type radio resource pool are non-overlapping in time domain comprises a meaning that: the first radio resource pool is non-overlapping with any said first-type radio resource pool in time domain.

In one embodiment, each of the radio resource pools in the present disclosure is a radio resource pool configured or indicated for the first node.

In one embodiment, when the first bit block is transmitted in a said first-type radio resource pool: a bit transmitted in the said first-type radio resource pool indicates whether the first bit block and a said first-type bit block are subject to combined coding.

In one subembodiment, when the bit transmitted in the said first-type radio resource pool is of a value equal to 0, the first bit block and the said first-type bit block are combined coded; when the bit transmitted in the said first-type radio resource pool is of a value equal to 1, the first bit block is individually coded.

In one subembodiment, when the bit transmitted in the said first-type radio resource pool is of a value equal to 1, the first bit block and the said first-type bit block are combined coded; when the bit transmitted in the said first-type radio resource pool is of a value equal to 0, the first bit block is individually coded.

In one embodiment, the first node receives a first signaling; and the first node transmits a first bit block, or, drops transmitting a bit block which indicates a first status; herein, the first status is fulfilled, the first status being a status related to reception of a bit block scheduled by the first signaling; the first signaling is used to determine a first radio resource pool; a first-type radio resource pool is reserved for a first-type bit block; when the first radio resource pool and the first-type radio resource pool are non-overlapping in time domain, the first transmitter drops transmitting a bit block which indicates the first status; when the first radio resource pool and a said first-type radio resource pool are overlapping in time domain, the first transmitter transmits the first bit block in a said first-type radio resource pool, the first bit block indicating the first status, the first bit block does not belong to the first-type bit block.

In one subembodiment, the first radio resource pool is reserved for a bit block which indicates a second status, the second status being different from the first status, the first status and the second status are both statuses related to reception of a bit block scheduled by the first signaling.

In one subembodiment, the first status is: a bit block scheduled by the first signaling being correctly received (or, being correctly decoded).

In one subembodiment, the first status is: a bit block scheduled by the first signaling not being correctly received (nor being correctly decoded).

In one subembodiment, the first radio resource pool comprises a radio resource occupied by a PUCCH resource, while a said first-type radio resource pool comprises a radio resource occupied by a PUSCH.

In one subembodiment, each bit comprised in the first bit block denotes a NACK.

In one subembodiment, each bit comprised in the first bit block denotes an ACK.

In one subembodiment, when the number of bits comprised in the first bit block is no greater than a first threshold, the first node transmits the first bit block in a said first-type radio resource pool having an earliest start time among the multiple said first-type radio resource pools; when the number of bits comprised in the first bit block is greater than a first threshold, the first node transmits the first bit block in a said first-type radio resource pool occupying most resources among the multiple said first-type radio resource pools.

### Embodiment 2

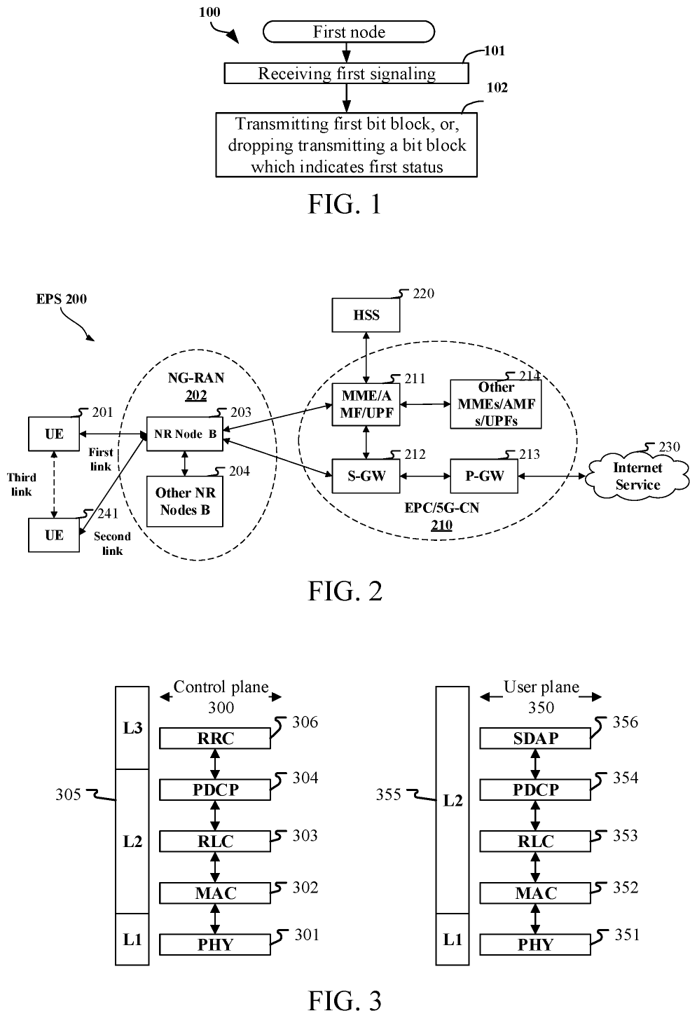

Embodiment 2 illustrates a schematic diagram of a network architecture according to the present disclosure, as shown in FIG. 2.

FIG. 2 is a diagram illustrating a network architecture 200 of 5G NR, Long-Term Evolution (LTE) and Long-Term Evolution Advanced (LIE-A) systems. The 5G NR or LIE network architecture 200 may be called an Evolved Packet System (EPS) 200 or other suitable terminology. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present disclosure can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/ Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present disclosure.

In one embodiment, the UE 241 corresponds to the second node in the present disclosure.

In one embodiment, the gNB 203 corresponds to the first node in the present disclosure.

In one embodiment, the gNB 203 corresponds to the second node in the present disclosure.

In one embodiment, the UE 241 corresponds to the first node in the present disclosure.

In one embodiment, the UE 201 corresponds to the second node in the present disclosure.

### Embodiment 3

Embodiment 3 illustrates a schematic diagram of a radio protocol architecture of a user plane and a control plane according to the present disclosure, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present disclosure. The layer 2 (L2) 305 is above the PHY 301, and is in charge of the link between the first communication node and the second communication node or between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the first signaling in the present disclosure is generated by the RRC sublayer 306.

In one embodiment, the first signaling in the present disclosure is generated by the MAC sublayer 302.

In one embodiment, the first signaling in the present disclosure is generated by the MAC sublayer 352.

In one embodiment, the first signaling in the present disclosure is generated by the PHY 301.

In one embodiment, the first signaling in the present disclosure is generated by the PHY 351.

In one embodiment, the second signaling in the present disclosure is generated by the RRC sublayer 306.

In one embodiment, the second signaling in the present disclosure is generated by the MAC sublayer 302.

In one embodiment, the second signaling in the present disclosure is generated by the MAC sublayer 352.

In one embodiment, the second signaling in the present disclosure is generated by the PHY 301.

In one embodiment, the second signaling in the present disclosure is generated by the PHY 351.

In one embodiment, the first bit block in the present disclosure is generated by the RRC sublayer 306.

In one embodiment, the first bit block in the present disclosure is generated by the SDAP sublayer 356.

In one embodiment, the first bit block in the present disclosure is generated by the MAC sublayer 302.

In one embodiment, the first bit block in the present disclosure is generated by the MAC sublayer 352.

In one embodiment, the first bit block in the present disclosure is generated by the PHY 301.

In one embodiment, the first bit block in the present disclosure is generated by the PHY 351.

In one embodiment, the second bit block in the present disclosure is generated by the RRC sublayer 306.

In one embodiment, the second bit block in the present disclosure is generated by the SDAP sublayer 356.

In one embodiment, the second bit block in the present disclosure is generated by the MAC sublayer 302.

In one embodiment, the second bit block in the present disclosure is generated by the MAC sublayer 352.

In one embodiment, the second bit block in the present disclosure is generated by the PHY 301.

In one embodiment, the second bit block in the present disclosure is generated by the PHY 351.

In one embodiment, the first signal in the present disclosure is generated by the PHY 301.

In one embodiment, the first signal in the present disclosure is generated by the PHY 351.

### Embodiment 4

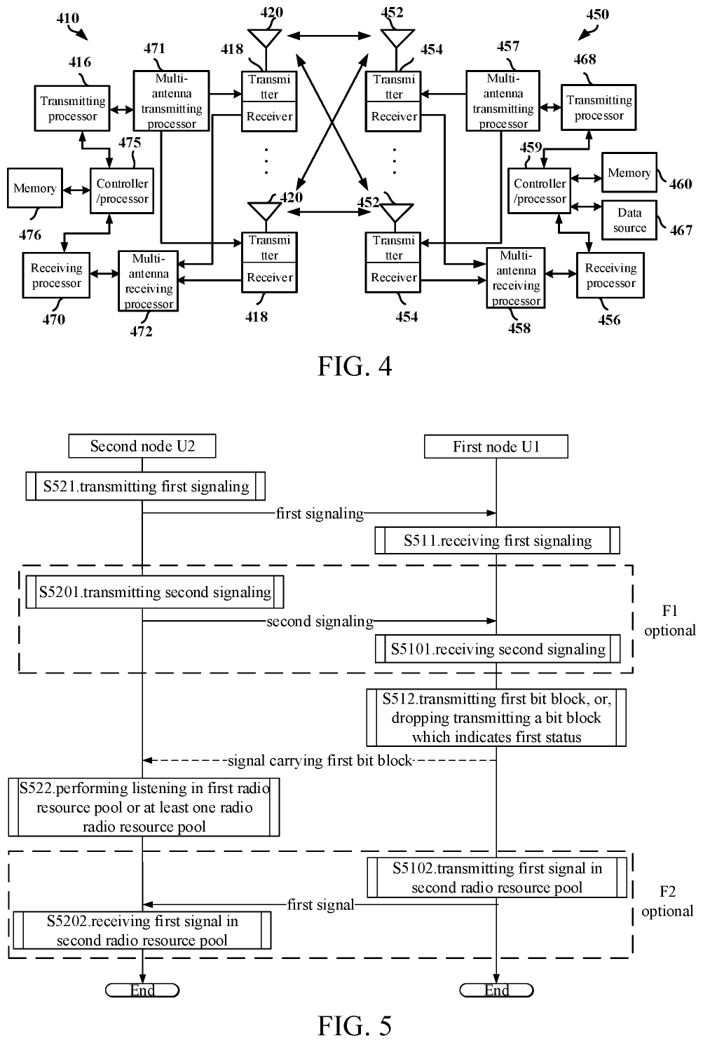

Embodiment 4 illustrates a schematic diagram of a first communication device and a second communication device according to the present disclosure, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present disclosure comprises the second communication device 450, and the second node in the present disclosure comprises the first communication device 410.

In one subembodiment, the first node is a UE, and the second node is a UE.

In one subembodiment, the first node is a UE, and the second node is a relay node.

In one subembodiment, the first node is a relay node, and the second node is a UE.

In one subembodiment, the first node is a UE, and the second node is a base station.

In one subembodiment, the first node is a relay node, and the second node is a base station.

In one subembodiment, the second node is a UE, and the first node is a base station.

In one subembodiment, the second node is a relay node, and the first node is a base station.

In one subembodiment, the second communication device 450 comprises: at least one controller/processor; the at least one controller/processor is in charge of HARQ operation.

In one subembodiment, the first communication device 410 comprises: at least one controller/processor; the at least one controller/processor is in charge of HARQ operation.

In one subembodiment, the first communication device 410 comprises: at least one controller/processor; the at least one controller/processor is in charge of error detections using ACK and/or NACK protocols to support HARQ operation.

In one embodiment, the second communication node 450 comprises at least one processor and at least one memory, the at least one memory comprises computer program codes; the at least one memory and the computer program codes are configured to be used in collaboration with the at least one processor. the second communication node 450 at least receives the first signaling in the present disclosure; transmits the first bit block in the present disclosure, or, drops transmitting a bit block which indicates the first status in the present disclosure; herein, the first signaling is used to determine a first radio resource pool in the present disclosure; the first status in the present disclosure is associated with the first signaling; the first-type radio resource pool in the present disclosure is reserved for first-type bit blocks in the present disclosure; when the first radio resource pool and the first-type radio resource pool are non-overlapping in time domain, dropping transmitting the bit block which indicates the first status; when the first radio resource pool and a said first-type radio resource pool are overlapping in time domain, transmitting the first bit block in the said first-type radio resource pool, the first bit block indicating the first status, the first bit block does not belong to the first-type bit block.

In one subembodiment, the second communication device 450 corresponds to the first node in the present disclosure.

In one embodiment, the second communication node 450 comprises a memory that stores a computer readable instruction program, the computer readable instruction program generates actions when executed by at least one processor, which include: receiving the first signaling in the present disclosure; transmitting the first bit block in the present disclosure, or, dropping transmitting a bit block which indicates the first status in the present disclosure; herein, the first signaling is used to determine a first radio resource pool in the present disclosure; the first status in the present disclosure is associated with the first signaling; the first-type radio resource pool in the present disclosure is reserved for first-type bit blocks in the present disclosure; when the first radio resource pool and the first-type radio resource pool are non-overlapping in time domain, dropping transmitting the bit block which indicates the first status; when the first radio resource pool and a said first-type radio resource pool are overlapping in time domain, transmitting the first bit block in the said first-type radio resource pool, the first bit block indicating the first status, the first bit block does not belong to the first-type bit block.

In one subembodiment, the second communication device 450 corresponds to the first node in the present disclosure.

In one embodiment, the first communication device 410 comprises at least one processor and at least one memory, the at least one memory comprises computer program codes; the at least one memory and the computer program codes are configured to be used in collaboration with the at least one processor. the first communication node 410 at least transmits the first signaling in the present disclosure; and performs listening in the first radio resource pool in the present disclosure or at least one said first-type radio resource pool in the present disclosure; herein, the first signaling is used to determine the first radio resource pool in the present disclosure; the first-type radio resource pool in the present disclosure is reserved for the first-type bit blocks in the present disclosure; when the first radio resource pool and the first-type radio resource pool are non-overlapping in time domain, performing listening in the first radio resource pool; when the first radio resource pool and a said first-type radio resource pool are overlapping in time domain, performing listening in the said first-type radio resource pool.

In one subembodiment, the first communication device 410 corresponds to the second node in the present disclosure.

In one embodiment, the first communication device 410 comprises a memory that stores a computer readable instruction program, the computer readable instruction program generates actions when executed by at least one processor, which include: transmitting the first signaling in the present disclosure; performing listening in the first radio resource pool in the present disclosure or at least one first-type radio resource pool in the present disclosure; herein, the first signaling is used to determine the first radio resource pool in the present disclosure; the first-type radio resource pool in the present disclosure is reserved for the first-type bit blocks in the present disclosure; when the first radio resource pool and the first-type radio resource pool are non-overlapping in time domain, performing listening in the first radio resource pool; when the first radio resource pool and a said first-type radio resource pool are overlapping in time domain, performing listening in the said first-type radio resource pool.

In one subembodiment, the first communication device 410 corresponds to the second node in the present disclosure.

In one embodiment, at least one of the antenna 452, the receiver 454, the multi-antenna receiving processor 458, the receiving processor 456, the controller/processor 459, the memory 460, or the data source 467 is used for receiving the first signaling in the present disclosure.

In one embodiment, at least one of the antenna 420, the transmitter 418, the multi-antenna transmitting processor 471, the transmitting processor 416, the controller/processor 475 or the memory 476 is used for transmitting the first signaling in the present disclosure.

In one embodiment, at least one of the antenna 452, the transmitter 454, the multi-antenna transmitting processor 468, the controller/processor 459, the memory 460 or the data source 467 is used for transmitting the first bit block in the present disclosure.

In one embodiment, at least one of the antenna 420, the receiver 418, the multi-antenna receiving processor 472, the receiving processor 470, the controller/processor 475, or the memory 476 is used for receiving the first bit block in the present disclosure.

In one embodiment, at least one of the antenna 452, the receiver 454, the multi-antenna receiving processor 458, the receiving processor 456, the controller/processor 459, the memory 460, or the data source 467 is used for receiving the second signaling in the present disclosure.

In one embodiment, at least one of the antenna 420, the transmitter 418, the multi-antenna transmitting processor 471, the transmitting processor 416, the controller/processor 475 or the memory 476 is used for transmitting the second signaling in the present disclosure.

In one embodiment, at least one of the antenna 452, the transmitter 454, the multi-antenna transmitting processor 458, the transmitting processor 468, the controller/processor 459, the memory 460, or the data source 467 is used for transmitting the first signal in the present disclosure in the second radio resource pool in the present disclosure.

In one embodiment, at least one of the antenna 420, the receiver 418, the multi-antenna receiving processor 472, the receiving processor 470, the controller/processor 475 or the memory 476 is used for receiving the first signal in the present disclosure in the second radio resource pool in the present disclosure.

### Embodiment 5

Embodiment 5 illustrates a flowchart of radio signal transmission according to one embodiment of the present disclosure, as shown in FIG. 5. In FIG. 5, a first node U1 and a second node U2 are in communications via an air interface. In FIG. 5, steps marked by dotted-line boxes F1 and F2 are optional, in between signal transmission denoted by the broken line with arrow either exists or not.

The first node U1 receives a first signaling in step S511; and receives a second signaling in step S5101; transmits a first bit block, or, drops transmitting a bit block which indicates a first status in step S512; and transmits a first signal in a second radio resource pool in step S5102.

The second node U2 transmits a first signaling in step S521; and transmits a second signaling in step S5201; performs listening in a first radio resource pool or at least one first-type radio resource pool in step S522; and receives a first signal in a second radio resource pool in step S5202.

In Embodiment 5, the first signaling is used to determine a first radio resource pool; the first status is associated with the first signaling; a first-type radio resource pool is reserved for a first-type bit block; when the first radio resource pool and the first-type radio resource pool are non-overlapping in time domain, the first node U1 drops transmitting the bit block which indicates the first status; when the first radio resource pool and a said first-type radio resource pool are overlapping in time domain, the first node transmits the first bit block in the said first-type radio resource pool, the first bit block indicating the first status, the first bit block does not belong to the first-type bit block. the first status is fulfilled; the first radio resource pool is reserved for a bit block which indicates a second status, the second status being different from the first status, the first status and the second status are both statuses related to reception of a bit block; the first signal carries a second bit block; the second bit block belongs to the first-type bit blocks, the second radio resource pool is a said first-type radio resource pool, and the second signaling is used to indicate the second radio resource pool.

In one subembodiment of Embodiment 5, when the first radio resource pool is overlapping with multiple said first-type radio resource pools in time domain; a number of bits comprised in the first bit block is used to determine in which one of the multiple said first-type radio resource pools the first bit block is to be transmitted.

In one embodiment, the first node U1 is the first node in the present disclosure.

In one embodiment, the second node U2 is the second node in the present disclosure.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 includes a cellular link.

In one embodiment, an air interface between the second node U2 and the first node U1 is a PC5 interface.

In one embodiment, an air interface between the second node U2 and the first node U1 includes a sidelink.

In one embodiment, an air interface between the second node U2 and the first node U1 includes a radio interface between a base station and a UE.

In one embodiment, an air interface between the second node U2 and the first node U1 includes a radio interface between a UE and another UE.

In one embodiment, in the present disclosure, when two radio resource pools are overlapping in time domain, each of timeline condition(s) required to be fulfilled is fulfilled.

In one embodiment, the timeline condition(s) includes(include) a timeline condition needed to be fulfilled for performing multiplexing.

In one embodiment, the timeline condition(s) includes(include) one or more timeline conditions described in 3GPP TS38.213, chapter 9.2.5.

In one embodiment, two radio resource pools in the present disclosure belong to a same serving cell or respectively belong to different serving cells.

In one embodiment, a problem to be solved in the present disclosure comprises: how to process an uplink transmission in a case when a Physical Uplink Control CHannel (PUCCH) used for only ACK/ACK only reporting is overlapping with a Physical Uplink Shared CHannel (PUSCH).

In one embodiment, a problem to be solved in the present disclosure comprises: how to process an uplink transmission in a case when a PUCCH used for only ACK/ACK only reporting is overlapping with a PUSCH.

In one embodiment, an advantage of the scheme disclosed herein is that it helps integrate the scheme for UCI multiplexing in the existing protocol release (3GPP Release 16) and the NACK-only (or ACK-only) PUCCH feedback scheme.

In one embodiment, the steps marked by the dotted-line box F1 in FIG. 5 exist.

In one embodiment, the steps marked by the dotted-line box F1 in FIG. 5 do not exist.

In one embodiment, the steps marked by the dotted-line box F2 in FIG. 5 exist.

In one embodiment, the steps marked by the dotted-line box F2 in FIG. 5 do not exist.

### Embodiment 6

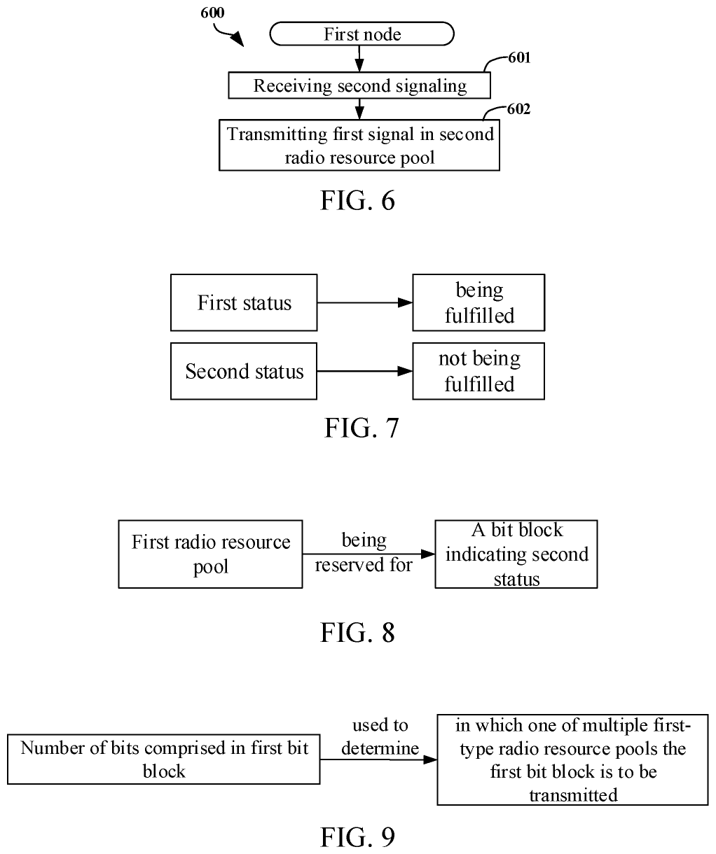

Embodiment 6 illustrates a flowchart of processing of a first node on a second signaling and a first signal according to one embodiment of the present disclosure, as shown in FIG. 6.

In Embodiment 6, the first node in the present disclosure receives a second signaling in step 601; and transmits a first signal in a second radio resource pool in step 602.

In Embodiment 6, the first signal carries a second bit block; the second bit block belongs to first-type bit blocks, the second radio resource pool is a first-type radio resource pool, and the second signaling is used to indicate the second radio resource pool.

In one embodiment, the second radio resource pool and the first radio resource pool in the present disclosure are overlapping in time domain, and a signal carrying the first bit block is transmitted in a said first-type radio resource pool.

In one embodiment, the second radio resource pool and the first radio resource pool in the present disclosure are overlapping in time domain, and a signal carrying the first bit block is transmitted in the second radio resource pool.

In one embodiment, the second radio resource pool and the first radio resource pool in the present disclosure are non-overlapping in time domain, and the first node drops transmitting a bit block which indicates the first status.

In one embodiment, at least one of two cases {the second radio resource pool and the first radio resource pool in the present disclosure are overlapping in time domain, or, the first radio resource pool and the first-type radio resource pool are non-overlapping in time domain} is fulfilled.

In one embodiment, the second signaling is dynamically configured.

In one embodiment, the second signaling comprises a layer 1 (L1) signaling.

In one embodiment, the second signaling comprises a layer 1 (L1) control signaling.

In one embodiment, the second signaling comprises a Physical Layer signaling.

In one embodiment, the second signaling comprises one or more fields in a physical layer signaling.

In one embodiment, the second signaling comprises a Higher Layer signaling.

In one embodiment, the second signaling comprises one or more fields in a Higher Layer signaling.

In one embodiment, the second signaling comprises a Radio Resource Control (RRC) signaling.

In one embodiment, the second signaling comprises a Medium Access Control layer Control Element (MAC CE) signaling.

In one embodiment, the second signaling comprises one or more fields in an RRC signaling.

In one embodiment, the second signaling comprises one or more fields in a MAC CE signaling.

In one embodiment, the second signaling is an RRC signaling.

In one embodiment, the second signaling is a MAC CE signaling.

In one embodiment, the second signaling comprises Downlink Control Information (DCI).

In one embodiment, the second signaling comprises one or more fields in a DCI.

In one embodiment, the second signaling is a piece of DCI.

In one embodiment, the second signaling is a field in a DCI.

In one embodiment, the second signaling comprises Sidelink Control Information (SCI).

In one embodiment, the second signaling comprises one or more fields in an SCI.

In one embodiment, the second signaling comprises one or more fields in an Information Element (IE).

In one embodiment, the second signaling is a DownLink Grant Signaling.

In one embodiment, the second signaling is an UpLink Grant Signaling.

In one embodiment, the second signaling is transmitted in a downlink physical layer control channel (i.e., a downlink channel only capable of bearing physical layer signaling).

In one embodiment, the second signaling is DCI format 1_0, for the specific definition of the DCI format 1_0, refer to 3GPP TS38.212, Chapter 7.3.1.2.

In one embodiment, the second signaling is DCI format 1_1, for the specific definition of the DCI format 1_1, refer to 3GPP TS38.212, Chapter 7.3.1.2.

In one embodiment, the second signaling is DCI format 1_2, for the specific definition of the DCI format 1_2, refer to 3GPP TS38.212, Chapter 7.3.1.2.

In one embodiment, the second signaling is DCI format 0_0, for the specific definition of the DCI format 0_0, refer to 3GPP TS38.212, Chapter 7.3.1.1.

In one embodiment, the second signaling is DCI format 0_1, for the specific definition of the DCI format 0_1, refer to 3GPP TS38.212, Chapter 7.3.1.1.

In one embodiment, the second signaling is DCI format 0_2, for the specific definition of the DCI format 0_2, refer to 3GPP TS38.212, Chapter 7.3.1.1.

In one embodiment, the first signal comprises a radio signal.

In one embodiment, the first signal comprises a radio frequency signal.

In one embodiment, the first signal comprises a baseband signal.

In one embodiment, the phrase that the first signal carries a second bit block has a meaning that: the first signal comprises an output by all or part of bits in the second bit block sequentially through some or all of CRC Insertion, Segmentation, Code Block (CB)-level CRC Insertion, Channel Coding, Rate Matching, Concatenation, Scrambling, Modulation, Layer Mapping, Precoding, Mapping to Resource Element, Multicarrier Symbol Generation, and Modulation and Upconversion.

In one embodiment, the second bit block comprises at least one bit.

In one embodiment, the second bit block comprises at least one Transport Block (TB).

In one embodiment, the second bit block comprises at least one Code Block (CB).

In one embodiment, the second bit block comprises at least one Code Block Group (CBG).

In one embodiment, the second bit block comprises a Channel State Information (CSI) report being indicated for transmission on a PUSCH.

In one embodiment, the second bit block is a bit block comprising at least one of a Transport Block (TB) or a CSI report being indicated for transmission in a PUSCH.

In one embodiment, the second bit block is a bit block required to be transmitted on a PUSCH.

In one embodiment, the second bit block comprises a periodic CSI report.

In one embodiment, the second bit block comprises information bits in a periodic CSI report.

In one embodiment, the second bit block comprises a semi-persistent CSI report.

In one embodiment, the second bit block comprises information bits in a semi-persistent CSI report.

In one embodiment, the second bit block comprises a HARQ-ACK information bit for unicast services.

In one embodiment, the second bit block comprises a HARQ-ACK information bit for unicast services or information bits in a CSI report.

In one embodiment, the second signaling is used to configure the second radio resource pool.

In one embodiment, the second signaling group indicates the second radio resource pool.

In one embodiment, the second signaling group explicitly indicates the second radio resource pool.

In one embodiment, the second signaling group implicitly indicates the second radio resource pool.

In one embodiment, a field comprised in the second signaling is used to indicate the second radio resource pool.

In one embodiment, the second signaling indicates time-domain resources occupied by the second radio resource pool.

In one embodiment, the second signaling indicates frequency-domain resources occupied by the second radio resource pool.

In one embodiment, a field comprised in the second signaling is used to indicate time-domain resources occupied by the second radio resource pool.

In one embodiment, a field comprised in the second signaling is used to indicate frequency-domain resources occupied by the second radio resource pool.

In one embodiment, time-domain resources occupied by the second radio resource pool are associated with time-domain resources occupied by the second signaling.

In one embodiment, time-domain resources occupied by the second radio resource pool are associated with time-domain resources occupied by a bit block scheduled by the second signaling.

In one embodiment, frequency-domain resources occupied by the second radio resource pool are associated with frequency-domain resources occupied by the second signaling.

In one embodiment, frequency-domain resources occupied by the second radio resource pool are associated with frequency-domain resources occupied by a bit block scheduled by the second signaling.

### Embodiment 7

Embodiment 7 illustrates a schematic diagram of a first status and a second status according to one embodiment of the present disclosure, as shown in FIG. 7.

In Embodiment 7, a first status is fulfilled, and a second status is unfulfilled.

In one embodiment, the first status is different from the second status.

In one embodiment, the second status is a status represented by a HARQ-ACK information bit.

In one embodiment, the first status is a status represented by a HARQ-ACK information bit.

In one embodiment, the first status being fulfilled comprises: the first status being triggered.

In one embodiment, the first status being fulfilled comprises: the first node performs reception of a bit block scheduled by the first signaling, yielding a reception result which is the first status.

In one embodiment, the first status being fulfilled comprises: the first node performs decoding of a bit block scheduled by the first signaling, yielding a decoding result which is the first status.

In one embodiment, the first status is a status related to reception of a bit block.

In one embodiment, the first status is a status related to reception of multiple bit blocks.

In one embodiment, a bit block scheduled by the first signaling is correctly received.

In one embodiment, a bit block scheduled by the first signaling is not correctly received.

In one embodiment, a bit block scheduled by the first signaling is correctly decoded.

In one embodiment, a bit block scheduled by the first signaling is not correctly decoded.

In one embodiment, the first node detects a bit block according to indication of the first signaling

In one embodiment, the first node attempts to receive a bit block according to indication of the first signaling.

In one embodiment, the first node receives a bit block according to indication of the first signaling.

In one embodiment, the first status comprises: a bit block scheduled by the first signaling being correctly received.

In one embodiment, the first status comprises: a bit block scheduled by the first signaling not being correctly received.

In one embodiment, the first status comprises: a bit block scheduled by the first signaling being correctly decoded.

In one embodiment, the first status comprises: a bit block scheduled by the first signaling not being correctly decoded.

In one embodiment, the first status is: a bit block scheduled by the first signaling being correctly received.

In one embodiment, the first status is: a bit block scheduled by the first signaling not being correctly received.

In one embodiment, the first status is: a bit block scheduled by the first signaling being correctly decoded.

In one embodiment, the first status is: a bit block scheduled by the first signaling not being correctly decoded.

In one embodiment, the second status comprises: a bit block scheduled by the first signaling being correctly received.

In one embodiment, the second status comprises: a bit block scheduled by the first signaling not being correctly received.

In one embodiment, the second status comprises: a bit block scheduled by the first signaling being correctly decoded.

In one embodiment, the second status comprises: a bit block scheduled by the first signaling not being correctly decoded.

In one embodiment, the second status is: a bit block scheduled by the first signaling being correctly received.

In one embodiment, the second status is: a bit block scheduled by the first signaling not being correctly received.

In one embodiment, the second status is: a bit block scheduled by the first signaling being correctly decoded.

In one embodiment, the second status is: a bit block scheduled by the first signaling not being correctly decoded.

In one embodiment, a bit block scheduled by the first signaling comprises one Transport Block (TB).

In one embodiment, a bit block scheduled by the first signaling comprises one codeblock.

In one embodiment, a bit block scheduled by the first signaling comprises one codeblock group.

In one embodiment, the first status comprises: a bit block being correctly received.

In one embodiment, the first status comprises: a bit block not being correctly received.

In one embodiment, the first status comprises: a bit block being correctly decoded.

In one embodiment, the first status comprises: a bit block not being correctly decoded.

In one embodiment, the first status is: a bit block being correctly received.

In one embodiment, the first status is: a bit block not being correctly received.

In one embodiment, the first status is: a bit block being correctly decoded.

In one embodiment, the first status is: a bit block not being correctly decoded.

In one embodiment, the first node receives a third bit block; the third bit block comprises one TB.

In one embodiment, the third bit block comprises one codeblock.

In one embodiment, the third bit block comprises at least one codeblock group.

In one embodiment, the first signaling is used to indicate scheduling information for the third bit block.

In one embodiment, the scheduling information in the present disclosure comprises: at least one of time-domain resources occupied, frequency-domain resources occupied, a Modulation and Coding Scheme (MCS), configuration information of DeModulation Reference Signals (DMRS), a Hybrid Automatic Repeat reQuest (HARQ) process number, a Redundancy Version (RV), a New Data Indicator (NDI), periodicity, a transmission antenna port, or a corresponding Transmission Configuration Indicator (TCI) state.

In one embodiment, the first node detects the third bit block according to indication of the first signaling.

In one embodiment, the first node attempts to receive the third bit block according to indication of the first signaling.

In one embodiment, the first node receives the third bit block according to indication of the first signaling.

In one embodiment, the first status comprises: the third bit block being correctly received.

In one embodiment, the first status comprises: the third bit block not being correctly received.

In one embodiment, the first status comprises: the third bit block being correctly decoded.

In one embodiment, the first status comprises: the third bit block not being correctly decoded.

In one embodiment, the first status comprises: all TBs (or CBGs) in the third bit block are correctly received.

In one embodiment, the first status comprises: none of TBs (or CBGs) in the third bit block are correctly received.

In one embodiment, the first status comprises: at least one TB (or CBG) in the third bit block is correctly decoded.

In one embodiment, the first status comprises: at least one TB (or CBG) in the third bit block is not correctly decoded.

In one embodiment, the first status is: the third bit block being correctly received.

In one embodiment, the first status is: the third bit block not being correctly received.

In one embodiment, the first status is: the third bit block being correctly decoded.

In one embodiment, the first status is: the third bit block not being correctly decoded.

In one embodiment, the first status is: all TBs (or CBGs) in the third bit block are correctly received.

In one embodiment, the first status is: none of TBs (or CBGs) in the third bit block are correctly received.

In one embodiment, the first status is: at least one TB (or CBG) in the third bit block is correctly decoded.

In one embodiment, the first status is: at least one TB (or CBG) in the third bit block is not correctly decoded.

In one embodiment, the second status comprises: the third bit block being correctly received.

In one embodiment, the second status comprises: the third bit block not being correctly received.

In one embodiment, the second status comprises: the third bit block being correctly decoded.

In one embodiment, the second status comprises: the third bit block not being correctly decoded.

In one embodiment, the second status comprises: all TBs (or CBGs) in the third bit block are correctly received.

In one embodiment, the second status comprises: none of TBs (or CBGs) in the third bit block are correctly received.

In one embodiment, the second status comprises: at least one TB (or CBG) in the third bit block is correctly decoded.

In one embodiment, the second status comprises: at least one TB (or CBG) in the third bit block is not correctly decoded.

In one embodiment, the second status is: the third bit block being correctly received.

In one embodiment, the second status is: the third bit block not being correctly received.

In one embodiment, the second status is: the third bit block being correctly decoded.

In one embodiment, the second status is: the third bit block not being correctly decoded.

In one embodiment, the second status is: all TBs (or CBGs) in the third bit block are correctly received.

In one embodiment, the second status is: none of TBs (or CBGs) in the third bit block are correctly received.

In one embodiment, the second status is: at least one TB (or CBG) in the third bit block is correctly decoded.

In one embodiment, the second status is: at least one TB (or CBG) in the third bit block is not correctly decoded.

In one embodiment, the first node receives multiple bit blocks.

In one embodiment, the first node correctly receives multiple bit blocks.

In one embodiment, the first node correctly decodes multiple bit blocks.

In one embodiment, the first node does not receive any of multiple bit blocks correctly.

In one embodiment, the first node does not decode any of multiple bit blocks correctly.

In one embodiment, the first node correctly receives at least one bit block of multiple bit blocks.

In one embodiment, the first node correctly decodes at least one bit block of multiple bit blocks.

In one embodiment, the first node does not correctly receive at least one bit block of multiple bit blocks.

In one embodiment, the first node does not correctly decode at least one bit block of multiple bit blocks.

In one embodiment, any of the multiple bit blocks comprises one TB.

In one embodiment, any of the multiple bit blocks comprises one codeblock.

In one embodiment, one of the multiple bit blocks comprises a code block group (CBG).

In one embodiment, the first signaling is used to indicate scheduling information for one of the multiple bit blocks.

In one embodiment, the multiple bit blocks are associated with a same HARQ-ACK codebook (or, sub-codebook).

In one embodiment, the first node receives multiple signalings, the multiple signalings being respectively used to indicate scheduling information for multiple bit blocks; the multiple signalings include the first signaling.

In one subembodiment, the first signaling is a last one of the multiple signalings.

In one subembodiment, the first signaling is a signaling last received among the multiple signaling.

In one subembodiment, the first signaling is a signaling belonging to a latest Monitoring Occasion among the multiple signalings.

In one subembodiment, each of the multiple signalings comprises a counter Downlink Assignment Index (DAI) field; Among the multiple signalings, the counter DAI field comprised in the first signaling indicates a maximum number of {serving cell, PDCCH monitoring occasion}-pair(s) ever accumulated.

In one embodiment, a signaling among the multiple signalings is dynamically configured.

In one embodiment, a signaling among the multiple signalings comprises a layer 1 (L1) signaling.

In one embodiment, a signaling among the multiple signalings comprises a layer 1 (L1) control signaling

In one embodiment, a signaling among the multiple signalings comprises a Physical Layer signaling.

In one embodiment, a signaling among the multiple signalings comprises one or more fields in a physical layer signaling.

In one embodiment, a signaling among the multiple signalings comprises a Higher Layer signaling.

In one embodiment, a signaling among the multiple signalings comprises one or more fields in a higher layer signaling.

In one embodiment, a signaling among the multiple signalings comprises a Radio Resource Control (RRC) signaling.

In one embodiment, a signaling among the multiple signalings comprises a Medium Access Control layer Control Element (MAC CE) signaling.

In one embodiment, a signaling among the multiple signalings comprises one or more fields in an RRC signaling.

In one embodiment, a signaling among the multiple signalings comprises one or more fields in a MAC CE signaling.

In one embodiment, a signaling among the multiple signalings is an RRC signaling.

In one embodiment, a signaling among the multiple signalings is a MAC CE signaling.

In one embodiment, a signaling among the multiple signalings comprises Downlink Control Information (DCI).

In one embodiment, a signaling among the multiple signalings comprises one or more fields in a DCI.

In one embodiment, a signaling among the multiple signalings is a DCI.

In one embodiment, a signaling among the multiple signalings is a field in a DCI.

In one embodiment, a signaling among the multiple signalings comprises Sidelink Control Information (SCI).

In one embodiment, a signaling among the multiple signalings comprises one or more fields in an SCI.

In one embodiment, a signaling among the multiple signalings comprises one or more fields in an Information Element (IE).

In one embodiment, a signaling among the multiple signalings is a DownLink Grant Signaling.

In one embodiment, a signaling among the multiple signalings is an UpLink Grant Signalling.

In one embodiment, a signaling among the multiple signalings is transmitted in a downlink physical layer control channel (i.e., a downlink channel only capable of bearing physical layer signaling).

In one embodiment, a signaling among the multiple signalings is DCI format 1_0, for the specific definition of the DCI format 1_0, refer to 3GPP TS38.212, Chapter 7.3.1.2.

In one embodiment, a signaling among the multiple signalings is DCI format 1_1, for the specific definition of the DCI format 1_1, refer to 3GPP TS38.212, Chapter 7.3.1.2.

In one embodiment, a signaling among the multiple signalings is DCI format 1_2, for the specific definition of the DCI format 1_2, refer to 3GPP TS38.212, Chapter 7.3.1.2.

In one embodiment, a signaling in the first signaling group is DCI format 0_0, for the specific definition of the DCI format 0_0, refer to 3GPP TS38.212, Chapter 7.3.1.1.

In one embodiment, a signaling in the first signaling group is DCI format 0_1, for the specific definition of the DCI format 0_1, refer to 3GPP TS38.212, Chapter 7.3.1.1.

In one embodiment, a signaling in the first signaling group is DCI format 0_2, for the specific definition of the DCI format 0_2, refer to 3GPP TS38.212, Chapter 7.3.1.1.

In one embodiment, the first node detects the multiple bit blocks according to indications of the multiple signalings.

In one embodiment, the first node attempts to receive the multiple bit blocks according to indications of the multiple signalings.

In one embodiment, the first node receives the multiple bit blocks according to indications of the multiple signalings.

In one embodiment, the first status is: the multiple bit blocks being correctly received.

In one embodiment, the first status is: none of the multiple bit blocks being correctly received.

In one embodiment, the first status is: at least one of the multiple bit blocks not being correctly received.

In one embodiment, the first status is: at least one of the multiple bit blocks being correctly received.

In one embodiment, the first status is: the multiple bit blocks being correctly decoded.

In one embodiment, the first status is: none of the multiple bit blocks being correctly decoded.

In one embodiment, the first status is: at least one of the multiple bit blocks not being correctly decoded.

In one embodiment, the first status is: at least one of the multiple bit blocks being correctly decoded.

In one embodiment, the second status is: the multiple bit blocks being correctly received.

In one embodiment, the second status is: none of the multiple bit blocks being correctly received.

In one embodiment, the second status is: at least one of the multiple bit blocks not being correctly received.

In one embodiment, the second status is: at least one of the multiple bit blocks being correctly received.

In one embodiment, the second status is: the multiple bit blocks being correctly decoded.

In one embodiment, the second status is: none of the multiple bit blocks being correctly decoded.

In one embodiment, the second status is: at least one of the multiple bit blocks not being correctly decoded.

In one embodiment, the second status is: at least one of the multiple bit blocks being correctly decoded.

In one embodiment, the first status is merely associated with the first signaling.

In one embodiment, the first status is merely associated with the first signaling as well as one or more signalings received no later than the first signaling.

In one embodiment, the first status is unrelated to any signaling received later than the first signaling.

In one embodiment, the first status is unrelated to any signaling received later than the first signaling.

### Embodiment 8

Embodiment 8 illustrates a schematic diagram illustrating a first radio resource pool according to one embodiment of the present disclosure, as shown in FIG. 8.

In Embodiment 8, a first radio resource pool is reserved for a bit block which indicates a second status.

In one embodiment, the first radio resource pool is reserved for transmissions of bit blocks which only comprise NACK.

In one embodiment, the first radio resource pool is reserved for transmissions of bit blocks which only comprise ACK.

In one embodiment, the first radio resource pool is reserved for transmissions of bit blocks which comprise at least one NACK.

In one embodiment, the first radio resource pool is reserved for transmissions of bit blocks which comprise at least one ACK.

In one embodiment, the first radio resource pool is not used for transmitting a bit block which indicates the first status in the present disclosure.

In one embodiment, the first radio resource pool is not used for transmitting any bit block comprising ACK.

In one embodiment, the first radio resource pool is not used for transmitting any bit block comprising NACK.

In one embodiment, the first radio resource pool is not used for transmitting any bit block which only comprises ACK.

In one embodiment, the first radio resource pool is not used for transmitting any bit block which only comprises NACK.

### Embodiment 9

Embodiment 9 illustrates a schematic diagram of relationship between a number of bits comprised in a first bit block and a first-type air-interface resource pool used for transmitting a first bit block according to one embodiment of the present disclosure, as shown in FIG. 9.

In Embodiment 9, the first radio resource pool in the present disclosure is overlapping with multiple first-type radio resource pools in time domain; a number of bits comprised in a first bit block is used to determine in which one of the multiple said first-type radio resource pools the first bit block is to be transmitted.

In one embodiment, when the first radio resource pool is overlapping with multiple said first-type radio resource pools in time domain: when the number of bits comprised in the first bit block is no greater than a first threshold, the first node in the present disclosure transmits the first bit block in a said first-type radio resource pool having an earliest start time among the multiple said first-type radio resource pools; when the number of bits comprised in the first bit block is greater than a first threshold, the first node in the present disclosure transmits the first bit block in a said first-type radio resource pool occupying most resources among the multiple said first-type radio resource pools.

In one embodiment, when the first radio resource pool is overlapping with multiple said first-type radio resource pools in time domain: when the number of bits comprised in the first bit block is smaller than a first threshold, the first node in the present disclosure transmits the first bit block in a said first-type radio resource pool having an earliest start time among the multiple said first-type radio resource pools; when the number of bits comprised in the first bit block is no smaller than a first threshold, the first node in the present disclosure transmits the first bit block in a said first-type radio resource pool occupying most resources among the multiple said first-type radio resource pools.

In one embodiment, the first threshold is a positive integer.

In one embodiment, the first threshold is no greater than 1706.

In one embodiment, the first threshold is default.

In one embodiment, the first threshold is configured by a higher layer signaling.

In one embodiment, the first threshold is configured by a RRC layer signaling.

In one embodiment, the first threshold is configured by a MAC CE signaling.

In one embodiment, the occupying most resources includes: occupying most REs.

In one embodiment, the occupying most resources includes: occupying most time-domain resources.

In one embodiment, the occupying most resources includes: occupying most frequency-domain resources.

In one embodiment, the occupying most resources includes: occupying most time-frequency resources.

### Embodiment 10

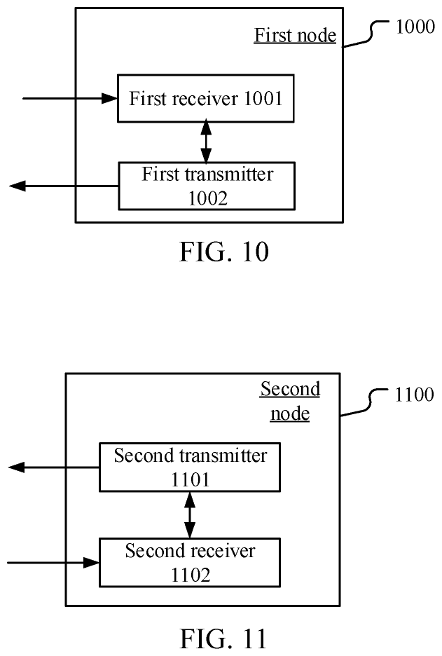

Embodiment 10 illustrates a structure block diagram of a processing device in a first node, as shown in FIG. 10. In FIG. 10, a processing device 1000 in the first node is comprised of a first receiver 1001 and a first transmitter 1002.

In one embodiment, the first node 1000 is a UE.

In one embodiment, the first node 1000 is a relay node.

In one embodiment, the first node 1000 is vehicle-mounted communication equipment.

In one embodiment, the first node 1000 is a UE supporting V2X communications.

In one embodiment, the first node 1000 is a relay node supporting V2X communications.

In one embodiment, the first receiver 1001 comprises at least one of the antenna 452, the receiver 454, the multi-antenna receiving processor 458, the receiving processor 456, the controller/processor 459, the memory 460 or the data source 467 in FIG. 4 of the present disclosure.

In one embodiment, the first receiver 1001 comprises at least the first five of the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1001 comprises at least the first four of the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1001 comprises at least the first three of the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1001 comprises at least the first two of the antenna 452, the receiver 454, the multi-antenna receiving processor 458, the receiving processor 456, the controller/processor 459, the memory 460 and the data source 467 in FIG. 4 of the present disclosure.

In one embodiment, the first transmitter 1002 comprises at least one of the antenna 452, the transmitter 454, the multi-antenna transmitting processor 457, the transmitting processor 468, the controller/processor 459, the memory 460 or the data source 467 in FIG. 4 of the present disclosure.

In one embodiment, the first transmitter 1002 comprises at least the first five of the antenna 452, the transmitter 454, the multi-antenna transmitting processor 457, the transmitting processor 468, the controller/processor 459, the memory 460 and the data source 467 in FIG. 4 of the present disclosure.

In one embodiment, the first transmitter 1002 comprises at least the first four of the antenna 452, the transmitter 454, the multi-antenna transmitting processor 457, the transmitting processor 468, the controller/processor 459, the memory 460 and the data source 467 in FIG. 4 of the present disclosure.

In one embodiment, the first transmitter 1002 comprises at least the first three of the antenna 452, the transmitter 454, the multi-antenna transmitting processor 457, the transmitting processor 468, the controller/processor 459, the memory 460 and the data source 467 in FIG. 4 of the present disclosure.

In one embodiment, the first transmitter 1002 comprises at least the first two of the antenna 452, the transmitter 454, the multi-antenna transmitting processor 457, the transmitting processor 468, the controller/processor 459, the memory 460 and the data source 467 in FIG. 4 of the present disclosure.

In Embodiment 10, the first receiver 1001 receives a first signaling; the first transmitter 1002 transmits a first bit block, or, drops transmitting a first bit block which indicates a first status; herein, the first signaling is used to determine a first radio resource pool; the first status is associated with the first signaling; a first-type radio resource pool is reserved for a first-type bit block; when the first radio resource pool and the first-type radio resource pool are non-overlapping in time domain, the first transmitter 1002 drops transmitting the bit block which indicates the first status; when the first radio resource pool and a said first-type radio resource pool are overlapping in time domain, the first transmitter 1002 transmits the first bit block in the said first-type radio resource pool, the first bit block indicating the first status, the first bit block does not belong to the first-type bit block.

In one embodiment, the first status is fulfilled.

In one embodiment, the first status is a status related to reception of a bit block.

In one embodiment, the first radio resource pool is reserved for a bit block which indicates a second status, the second status being different from the first status, the first status and the second status are both statuses related to reception of a bit block.

In one embodiment, each bit comprised in the first bit block denotes a NACK.

In one embodiment, the first receiver 1001 receives a second signaling; the first transmitter 1002 transmits a first signal in a second radio resource pool, the first signal carrying a second bit block; herein, the second bit block belongs to the first-type bit blocks, the second radio resource pool is a said first-type radio resource pool, and the second signaling is used to indicate the second radio resource pool.

In one embodiment, when the first radio resource pool is overlapping with multiple said first-type radio resource pools in time domain: a number of bits comprised in the first bit block is used to determine in which one of the multiple said first-type radio resource pools the first transmitter 1002 will transmit the first bit block.

### Embodiment 11

Embodiment 11 illustrates a structure block diagram a processing device in a second node according to one embodiment of the present disclosure, as shown in FIG. 11. In FIG. 11, a processing device 1100 in the second node is comprised of a second transmitter 1101 and a second receiver 1102.

In one embodiment, the second node 1100 is a UE.

In one embodiment, the second node 1100 is a base station.

In one embodiment, the second node 1100 is a relay node.

In one embodiment, the second node 1100 is vehicle-mounted communication equipment.

In one embodiment, the second node 1100 is UE supporting V2X communications.

In one embodiment, the second transmitter 1101 comprises at least one of the antenna 420, the transmitter 418, the multi-antenna transmitting processor 471, the transmitting processor 416, the controller/processor 475 or the memory 476 in FIG. 4 of the present disclosure.

In one embodiment, the second transmitter 1101 comprises at least the first five of the antenna 420, the transmitter 418, the multi-antenna transmitting processor 471, the transmitting processor 416, the controller/processor 475 and the memory 476 in FIG. 4 of the present disclosure.

In one embodiment, the second transmitter 1101 comprises at least the first four of the antenna 420, the transmitter 418, the multi-antenna transmitting processor 471, the transmitting processor 416, the controller/processor 475 and the memory 476 in FIG. 4 of the present disclosure.

In one embodiment, the second transmitter 1101 comprises at least the first three of the antenna 420, the transmitter 418, the multi-antenna transmitting processor 471, the transmitting processor 416, the controller/processor 475 and the memory 476 in FIG. 4 of the present disclosure.

In one embodiment, the second transmitter 1101 comprises at least the first two of the antenna 420, the transmitter 418, the multi-antenna transmitting processor 471, the transmitting processor 416, the controller/processor 475 and the memory 476 in FIG. 4 of the present disclosure.

In one embodiment, the second receiver 1102 comprises at least one of the antenna 420, the receiver 418, the multi-antenna receiving processor 472, the receiving processor 470, the controller/processor 475 or the memory 476 in FIG. 4 of the present disclosure.

In one embodiment, the second receiver 1102 comprises at least the first five of the antenna 420, the receiver 418, the multi-antenna receiving processor 472, the receiving processor 470, the controller/processor 475 and the memory 476 in FIG. 4 of the present disclosure.

In one embodiment, the second receiver 1102 comprises at least the first four of the antenna 420, the receiver 418, the multi-antenna receiving processor 472, the receiving processor 470, the controller/processor 475 and the memory 476 in FIG. 4 of the present disclosure.

In one embodiment, the second receiver 1102 comprises at least the first three of the antenna 420, the receiver 418, the multi-antenna receiving processor 472, the receiving processor 470, the controller/processor 475 and the memory 476 in FIG. 4 of the present disclosure.

In one embodiment, the second receiver 1102 comprises at least the first two of the antenna 420, the receiver 418, the multi-antenna receiving processor 472, the receiving processor 470, the controller/processor 475 and the memory 476 in FIG. 4 of the present disclosure.

In Embodiment 11, the second transmitter 1101 transmits a first signaling; the second receiver 1102 performs listening in a first radio resource pool or at least one first-type radio resource pool; herein, the first signaling is used to determine a first radio resource pool; a first-type radio resource pool is reserved for a first-type bit block; when the first radio resource pool and the first-type radio resource pool are non-overlapping in time domain, the second receiver 1102 performs listening in the first radio resource pool; when the first radio resource pool and a said first-type radio resource pool are overlapping in time domain, the second receiver 1102 performs listening in the said first-type radio resource pool.

In one embodiment, the first radio resource pool is reserved for a bit block which indicates a second status, the second status being different from a first status, the first status and the second status are both statuses related to reception of a bit block.

In one embodiment, when the first radio resource pool and the first-type radio resource pool are non-overlapping in time domain, the second receiver 1102 performs listening on a bit block which indicates a second status in the first radio resource pool, and the second receiver 1102 does not perform listening on a bit block which indicates a first status in the first radio resource pool.

In one embodiment, when the first radio resource pool and a said first-type radio resource pool are overlapping in time domain, the second receiver 1102 performs listening on a bit block which indicates a first status or a second status in the said first-type radio resource pool.

In one embodiment, when the first radio resource pool is overlapping with multiple said first-type radio resource pools in time domain: In one embodiment, the second node 1100 determines that listening is performed on a bit block which indicates a first status or a second status, a number of bits comprised in the bit block which indicates the first status or the second status is used to determine in which one of the multiple said first-type radio resource pools the listening will be performed on the bit block which indicates the first status or the second status.

In one embodiment, the second transmitter 1101 transmits a second signaling; the second receiver 1102 receives a first signal in a second radio resource pool, the first signal carrying a second bit block; herein, the second bit block belongs to the first-type bit blocks, the second radio resource pool is a said first-type radio resource pool, and the second signaling is used to indicate the second radio resource pool.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present disclosure is not limited to any combination of hardware and software in specific forms. The first node in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station in the present disclosure includes but is not limited to macro-cellular base stations, micro-cellular base stations, home base stations, relay base station, eNB, gNB, Transmitter Receiver Point (TRP), GNSS, relay satellite, satellite base station, airborne base station, test apparatus, test equipment or test instrument, and other radio communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
a first receiver, receiving a first signaling; and
a first transmitter, transmitting a first bit block, or, dropping transmitting a bit block which indicates a first status;
wherein the first signaling is used to determine a first radio resource pool; the first status is associated with the first signaling; a first-type radio resource pool is reserved for a first-type bit block; when the first radio resource pool and the first-type radio resource pool are non-overlapping in time domain, the first transmitter drops transmitting a bit block which indicates the first status; when the first radio resource pool and a said first-type radio resource pool are overlapping in time domain, the first transmitter transmits the first bit block in a said first-type radio resource pool, the first bit block indicating the first status, the first bit block does not belong to the first-type bit block.

2. The first node according to claim 1, wherein when the first radio resource pool and a said first-type radio resource pool are overlapping in time domain, each of timeline condition(s) required to be fulfilled is fulfilled; the first radio resource pool is a second-type radio resource pool, the second-type radio resource pool being a radio resource pool reserved for a PUCCH, the first radio resource pool is non-overlapping with any of the second-type radio resource pools other than the first radio resource pool in time domain.

3. The first node according to claim 1, wherein the first status comprises: a bit block scheduled by the first signaling is correctly decoded.

4. The first node according to claim 1, wherein the first radio resource pool is reserved for a PUCCH, and the first-type radio resource pool is a radio resource occupied by a PUSCH.

5. The first node according to claim 2, wherein the first status comprises: a bit block scheduled by the first signaling is correctly decoded; each bit comprised in the first bit block represents an ACK.

6. The first node according to claim 5, wherein the first-type bit block is a bit block comprising at least one of a Transport Block (TB) or a CSI report being indicated for transmission in a PUSCH; the first-type radio resource pool is a radio resource occupied by a PUSCH.

7. The first node according to claim 1, comprising:
the first receiver, receiving multiple signalings, the multiple signalings comprising the first signaling;
wherein the multiple signalings are respectively used to indicate scheduling information for multiple bit blocks, any of the multiple bit blocks comprises a TB, and the multiple bit blocks are correctly decoded; the first status is: the multiple bit blocks being correctly decoded.

8. A second node for wireless communications, comprising:
a second transmitter, transmitting a first signaling; and
a second receiver, performing listening in a first radio resource pool or at least one first-type radio resource pool;
wherein the first signaling is used to determine a first radio resource pool; a first-type radio resource pool is reserved for a first-type bit block; when the first radio resource pool and the first-type radio resource pool are non-overlapping in time domain, the second receiver performs listening in the first radio resource pool; when the first radio resource pool and a said first-type radio resource pool are overlapping in time domain, the second receiver performs listening in the said first-type radio resource pool.

9. The second node according to claim 8, wherein the first radio resource pool is reserved for a bit block which indicates a second status, the second status being different from a first status, the first status and the second status are both statuses related to reception of a bit block.

10. The second node according to claim 9, wherein when the first radio resource pool and the first-type radio resource pool are non-overlapping in time domain, listening is performed on a bit block which indicates a second status in the first radio resource pool, and listening is not performed on a bit block which indicates a first status in the first radio resource pool.

11. The second node according to claim 9, wherein when the first radio resource pool and a said first-type radio resource pool are overlapping in time domain, listening is performed on a bit block which indicates a first status or a second status in the said first-type radio resource pool.

12. The second node according to claim 8, wherein the first status comprises: a bit block scheduled by the first signaling is correctly decoded; the first-type bit block is a bit block comprising at least one of a Transport Block (TB) or a CSI report being indicated for transmission in a PUSCH; the first-type radio resource pool is a radio resource occupied by a PUSCH.

13. A method in a first node for wireless communications, comprising:
receiving a first signaling; and
transmitting a first bit block, or, dropping transmitting a bit block which indicates a first status;
wherein the first signaling is used to determine a first radio resource pool; the first status is associated with the first signaling; a first-type radio resource pool is reserved for a first-type bit block; when the first radio resource pool and the first-type radio resource pool are non-overlapping in time domain, the first transmitter drops transmitting a bit block which indicates the first status; when the first radio resource pool and a said first-type radio resource pool are overlapping in time domain, the first transmitter transmits the first bit block in a said first-type radio resource pool, the first bit block indicating the first status, the first bit block does not belong to the first-type bit block.

14. The method in the first node according to claim 13, wherein when the first radio resource pool and a said first-type radio resource pool are overlapping in time domain, each of timeline condition(s) required to be fulfilled is fulfilled; the first radio resource pool is a second-type radio resource pool, the second-type radio resource pool being a radio resource pool reserved for a PUCCH, the first radio resource pool is non-overlapping with any of the second-type radio resource pools other than the first radio resource pool in time domain.

15. The method in the first node according to claim 13, wherein the first status comprises: a bit block scheduled by the first signaling is correctly decoded.

16. The method in the first node according to claim 13, wherein the first radio resource pool is reserved for a PUCCH, and the first-type radio resource pool is a radio resource occupied by a PUSCH.

17. The method in the first node according to claim 14, wherein the first status comprises: a bit block scheduled by the first signaling is correctly decoded; each bit comprised in the first bit block represents an ACK.

18. The method in the first node according to claim 17, wherein the first-type bit block is a bit block comprising at least one of a Transport Block (TB) or a CSI report being indicated for transmission in a PUSCH; the first-type radio resource pool is a radio resource occupied by a PUSCH.

19. The method in the first node according to claim 13, comprising:
receiving multiple signalings, the multiple signalings comprising the first signaling;
wherein the multiple signalings are respectively used to indicate scheduling information for multiple bit blocks, any of the multiple bit blocks comprises a TB, and the multiple bit blocks are correctly decoded; the first status is: the multiple bit blocks being correctly decoded.

20. The method in the first node according to claim 16, wherein the first-type bit block is a bit block comprising at least one of a Transport Block (TB) or a CSI report being indicated for transmission in a PUSCH; each bit comprised in the first bit block represents an ACK.
